(19) United States
(12) Patent Application Publication
(10) Pub. No.: US 2004/0170751 A1
(43) Pub. Date: Sep. 2, 2004

(54) Aerated confection containing particulate material and method of making same

(76) Inventors: Pradip Roy, Grand Rapids, MI (US); Emery Okos, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/745,129

(22) Filed: Dec. 22, 2003

Related U.S. Application Data
(60) Provisional application No. 60/435,989, filed on Dec. 23, 2002.

(51) Int. Cl. A23G 3/00

(52) U.S. Cl. 426/660

(57) ABSTRACT

An aerated confection containing particulate material and method for making the same is disclosed. The method allows the incorporation of particulate material at a level of from 1 to 50.0% by weight based on the total weight of the aerated confection. The aerated confection preferably includes hexametaphosphate as a gel-stiffening agent.

### RELATED APPLICATIONS

This application claims the benefit of U.S. Provisional Application No. 60/435,989, filed Dec. 23, 2002.

### STATEMENT REGARDING FEDERALLY SPONSORED RESEARCH

None

### BACKGROUND OF THE INVENTION

This invention relates generally to aerated confections such as marbits and marshmallows and, more particularly, to including particulate materials in such aerated confections.

Aerated confections such as marbits and marshmallows have been known for many years. A marbit is basically a marshmallow formulation that has been dried to a moisture level of generally less than 5%. Past formulations for marbits and marshmallows have included different colors, flavors, or both. Generally, the color has been added by utilizing dyes and the flavor has been added by utilizing flavor extracts or additives. One thing that has been lacking from past marbits and marshmallows has been the incorporation of particulate material into the formulation to produce a marbit or marshmallow containing chucks or pieces of other solids. It would be advantageous to develop a method enabling the incorporation of particulate material into marbits and marshmallows to produce additional textures, tastes, flavors, and to enhance the nutritional composition of the same.

### SUMMARY OF THE INVENTION

In general terms, this invention is an aerated confection comprising from 1.0 to 50% by weight based on the total weight of the aerated confection of a particulate material and having a moisture of from 1 to 5%.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a schematic diagram of an apparatus for carrying out the process according to the present invention;

FIG. 2 is an end view of a particulate feeder assembly according to the present invention;

FIG. 3 is a side view of the particulate feeder shown in FIG. 2; and

FIG. 4 is an end view of a feeder chamber designed according to the present invention.

### DETAILED DESCRIPTION OF A PREFERRED EMBODIMENT

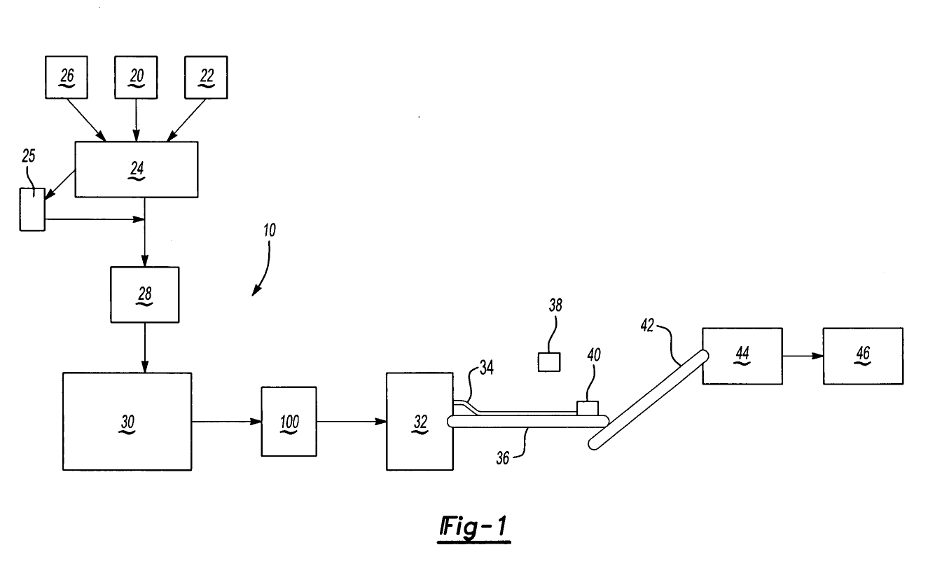

In FIG. 1, a schematic diagram of an apparatus for carrying out the present process is shown generally at 10. In an initial step, a sucrose solution is prepared in a first tank 20. Tank 20 is thermally controlled and includes a mixer. The finished sucrose solution is prepared with water to have a solids level of from 82 to 89% and more preferably from 84 to 87%. Achieving this final Brix may require that more water than necessary be used to fully hydrate the components of the sucrose solution and then the excess water must be removed, preferably by heating. In addition to sucrose the solution typically includes corn syrup, dextrose, or a mixture of corn syrup and dextrose. The sucrose solution can also be made without corn syrup, dextrose, or both, using instead maltose, lactose, glycerin, maltodextrin, a glucose syrup, or mixtures thereof. The components other than the sucrose are utilized to reduce the tendency for crystallization of the sucrose. In a preferred embodiment, the sucrose solution comprises sucrose, corn syrup, dextrose, and water. In such a sucrose solution there is preferably from 5.0% to 50.0% by weight of corn syrup, dextrose, substitutes for these noted above, or a combination thereof with the remainder comprising water and sucrose. In a typical preparation, the water, sucrose and corn syrup are initially mixed together and heated in first tank 20 to approximately 200° F. Once the sucrose has been hydrated the dextrose is added. Then the mixture is elevated to a temperature of from 243 to 246° F. with mixing to form the sucrose solution at the desired Brix.

A second component is the formation of a film-forming solution in a second tank 22. Second tank 22 is thermally controlled and includes a mixer. A preferred film-forming agent is gelatin; however, other film-forming agents that could be utilized include proteins such as albumin, soybean protein, or whey protein isolate. In addition, film forming agents can include whipping agents such as pectin, carboxymethyl cellulose, alginate, or a gum. Also mixtures of these film forming agents can be used. Gums that are typically utilized include guar gum, carrageenan, arabic gum, and xanthan gum. The preferred film-forming agent in the present invention is a gelatin, either type A or type B. Two especially preferred gelatins are 225B and 225A. When gelatin is the selected film-forming agent it is heated in water in the second tank 22 at approximately 170° F. to hydrate the film-forming agent and form the film-forming solution. When gelatin is utilized it is generally hydrated with water in a weight to weight ratio of 1:2; thus the solution is 33.33% gelatin and 66.67% water. The other film forming agents are also hydrated as known in the art. Typically at least 30 minutes are required for full hydration of the film-forming agent. Once hydrated, the film-forming solution is maintained at a temperature of from 150 to 165° F. in second tank 22.

The sucrose solution is then pumped into a third tank 24, which is also thermally controlled and includes mixing. The third tank 24 is initially set at a temperature of from 165 to 180° F. Preferably, the third tank 24 is initially set at a temperature of from 175 to 180° F. Once the sucrose solution is completely pumped into the third tank 24 it begins to cool to the initially set temperature. When the sucrose solution reaches a temperature of approximately 180° F. crystallization of the sucrose solution begins to occur. Once the sucrose solution has cooled to 180° F. additional components are added to the sucrose solution from a source tank 26 to form a mallow mix. For simplicity, only a single source tank 26 is shown, however, as would be understood by one of ordinary skill in the art numerous source tanks may be utilized, all feeding into third tank 24.

Once the sucrose solution reaches a temperature of 180° F., fruit solids can be added from a source tank 26 into the mallow mix in third tank 24. This step is optional and has been described in co-owned U.S. Provisional Application Serial No. 60/422,812 filed on Oct. 31, 2002. Preferably, the fruit solids are added in the form of a dry fruit powder, but wet fruit solids can also be added provided they have a very high solids content of at least 80%. Preferably, the amount of fruit solids on a dry weight basis based on the final weight of the mallow mix comprises from 0.5 to 20.0%, more preferably from 0.5 to 10.0%, and most preferably from 2.0 to 5.0% by weight. The fruit solids can be prepared by a number of known techniques including: drum dried fruit, spray dried fruit, freeze dried fruit, or evaporated fruit puree at a high solids of over 80%. The fruit solids added to third tank 24 can comprise a mixture of any combination of fruit solids that is desired. It is important, if fruit is added, to add the fruit solids at this point in the procedure. To maintain the nutritional content of the fruit solids it is important that they not be exposed to high temperatures of generally greater than 180 ° F. Because, unlike the prior art the present invention optionally uses fruit solids as either dry powders or very high solids wet solids it is not necessary to drive off excess water that is present in the prior art. The prior art has suggested fruit juices or purees, both of which have very high water levels, thus they must be added to the sucrose solution at high temperatures during hydration of the sucrose solution so the excess water can be driven off.

Then a seed sugar in an amount of from 1.0 to 20.0% on a dry weight basis based on the total mallow mix weight is added to the mallow mix, whether it has added fruit or not. Seed sugars ranked in increasing grain size that are useful in the present invention include: 10× powdered sugar; 6× powdered sugar; Bakers Special sugar; fruit sugar; extra fine granulated sugar; fine granulated sugar; and mixtures thereof. Any of these seed sugars alone or in combination is suitable. Especially preferred is a powdered sugar sized to 5% on a United States Standard (USS) 100 mesh screen and 80% through a 200 USS mesh screen. Also especially preferred is a Bakers Special Sugar sized to 2% on a 50 USS mesh screen and 5% through a 200 USS mesh screen. The mallow mix with the added seed sugar and fruit solids continues to be cooled and mixed until the temperature reaches approximately 165° F. Once the mallow mix reaches a temperature of 160° F., the film-forming solution from the second tank 22 is added to third tank 24. The film-forming solution is added in sufficient amount to provide an amount of preferably from 0.5 to 15.0% by weight on a dry weight basis of the film forming agent or agents based on the total weight of the mallow mix. More preferably the film forming agent or agents are present in an amount of from 1.0 to 7.0% by weight on a dry weight basis based on the total weight of the mallow mix. Also flavors, colors, and a colloidal solution of hexametaphosphate are added from a source tank 26 to the mallow mix. Flavor and colors are added in amounts of from 0.1 to 3.0% by weight. The preferred hexametaphosphate is the sodium salt, although the potassium salt can also be utilized. The hexametaphosphate is preferably added in an amount of from 0.01 to 0.2% and more preferably from 0.02 to 0.05% by weight. The hexametaphosphate is necessary to allow the film-forming solution to firmly gel the final mallow mix to enable formation of an extrudable mass that can be cut into discrete pieces, as described below.

The mallow mix is mixed and cooled until it reaches a temperature of approximately 145° F. The preferred density of the mallow mix is from 11.0 to 12.0 pounds per gallon with a moisture level of from 10 to 30% at this point in the procedure. If the fruit solids are added as a wet solids solution the contents of third tank 24 can be passed through an evaporator 25 such as a rotary evaporator, or microfilm cooker or other rapid evaporator to bring the final solids back to a range of from 82 to 86%.

In a next step the mallow mix formed in third tank 24 is pumped into an aerator 28. The aerator 28 is any of a commonly known variety such as Mondo Mixer™ or an Oakes™-type aerator. The aerator 28 is thermally controlled to a temperature range of from 125 to 165° F. The mallow mix is aerated to a density of from 1.5 to 4.0 pounds per gallon and more preferably from 2.0 to 3.0 pounds per gallon. The aerated mallow mix is then pumped from aerator 28 through a thermally controlled tube 30. The aerated mallow mix is preferably cooled to a temperature range of from 90 to 170° F., more preferably to a temperature of from 115 to 145° F., and most preferably to a temperature of from 125 to 135° F.

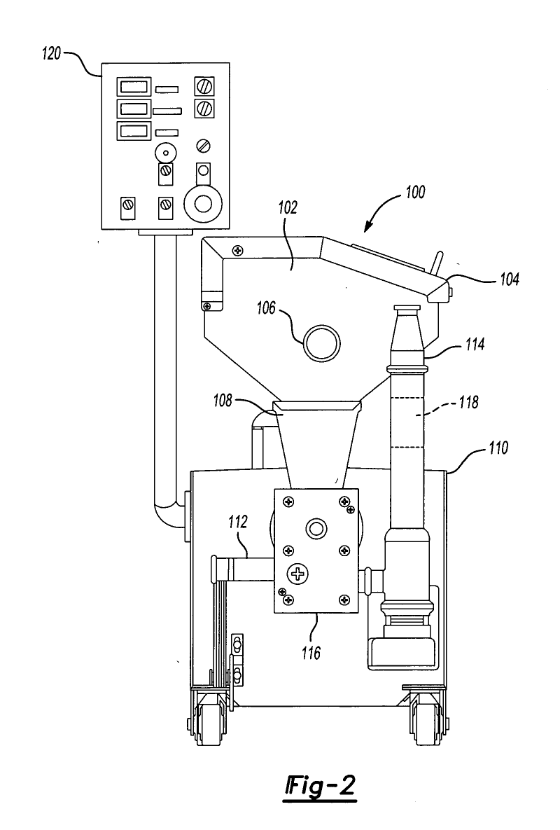

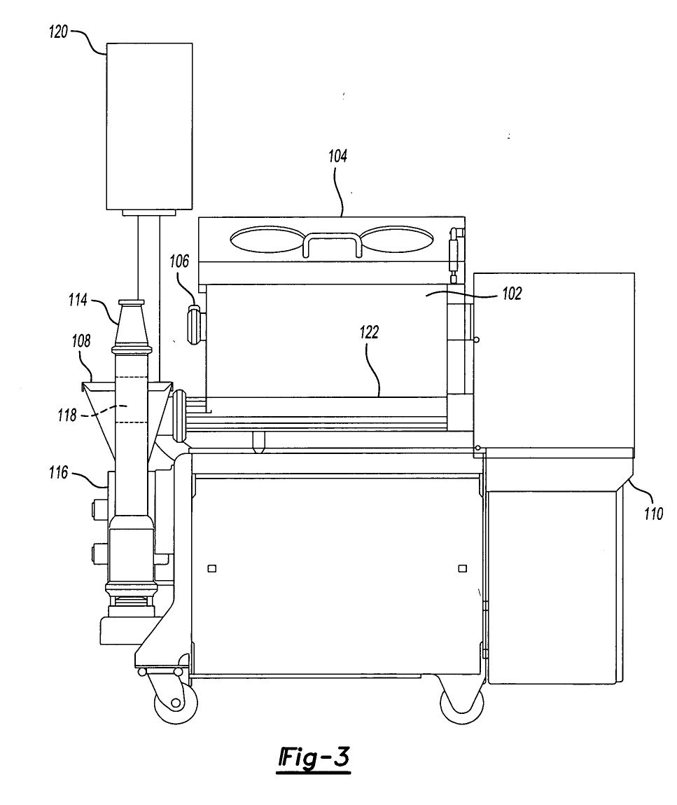

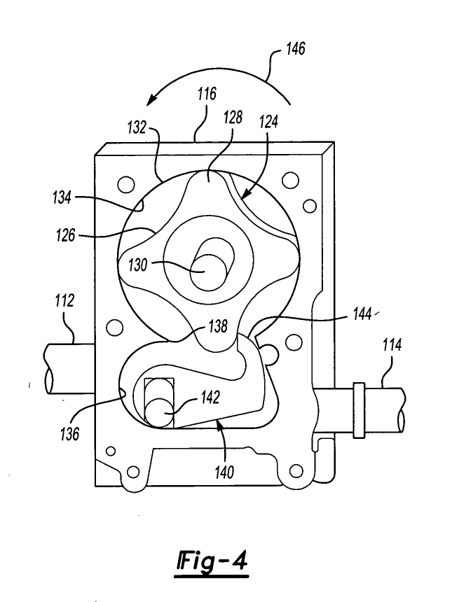

The chilled, aerated mallow mix is then pumped to a particulate feeder assembly 100. The particulate feeder assembly 100 adds particulate material of choice to the aerated mallow mix. The particulate feeder assembly 100 is designed to maintain the aerated mallow mix under pressure and to incorporate the particulate material into the moving mallow mix. Numerous designs can be used for incorporating the particulate material. Once such suitable design is available from Waukesha Cherry-Burrell Ice Cream, Louisville, Ky. and it will be described below. Suitable models include the IF-410S and IF-820S ingredient feeders. The feeder assembly 100 is more fully detailed in FIGS. 2-4. The feeder assembly 100 includes a primary hopper 102 for receiving the particulate material. The primary hopper includes a lid 104 and a rotating agitator 106. An auger 122 in the bottom of the primary hopper 102 moves the particulate material from the primary hopper 102 into a secondary hopper 108. The hoppers 102 and 108 are secured to a motor housing 110 containing the motors, not shown. An inlet line 112 is connected to an outlet line 114 through a feeder chamber 116. The outlet line 114 includes an in-line static mixer 118. The inlet line 112 is connected to the thermally controlled tube 30 and the outlet line 114 is connected to an extruder 32. The particulate material is taken from the secondary hopper 108 by the feeder chamber 116 and added into the mallow mix in an air tight manner so there is no change in the pressure of the mallow mix. A control panel 120 permits an operator to control the parameters of the feeder assembly 100 such as feed rate and rotor speed.

The feeder chamber 116 includes a rotor 124 having a plurality of spaced apart concave regions 126 separated by arms 128. The rotor 124 is mounted to a drive shaft 130. The rotor 124 is housed in an upper chamber 132 and the arms 128 contact an inner wall 134 of the upper chamber 132. The upper chamber 132 is connected to a lower chamber 136 through an opening 138. The lower chamber 136 is connected to both the inlet 112 and the outlet 114. The lower chamber 136 includes a scraper assembly 140 that is mounted to a shaft 142 and spring biased toward the rotor 124. The scraper assembly 140 includes a blade 144 that contacts the rotor 124 because of the spring biasing and scrapes the outside periphery of the rotor 124 as the rotor 124 rotates. The rotor 124 rotates in a counter clockwise direction as shown by arrow 146.

In operation, each of the concave regions 126 receives particulate material from the auger 122 as the concave region 126 passes through the 12 o'clock position. The arms 128 provide air tight seals between the concave regions 126 in the upper chamber 132. As the rotor 124 continues to rotate the particulate material falls though the opening 138 and into the lower chamber 136 as the leading arm 128 of the concave region 126 passes into the opening 138. Because the arms 128 contact the inner wall 134 this transfer of the particulate material can occur in an air tight manner and the moving mallow mix is maintained under pressure. The blade 144 scrapes any particulate material off the concave region 126 and into the lower chamber 136. The opening 138 is sized relative to the distance between the arms 128 so that mallow mix is always kept under pressure.

The feeder assembly 100 allows a wide variety of particulate material to be incorporated into the mallow mix. Examples of some of the suitable materials include: soft candy pieces, chocolate chips, chocolate chunks, bittersweet chocolate pieces, white chocolate pieces, butter scotch pieces, caramel pieces, solid peanut butter pieces, fruit pieces, hard candy pieces, nut pieces, graham cracker crumbs, oreo® cookie crumbs, cookie crumbs, and mixtures of any of these particulates. The particulate is added in amounts of from 1 to 50% by weight based on the weight of the mallow mix, more preferably in amounts of from 5 to 40% and most preferably in amounts of from 10 to 30% by weight. The size of the particulate material can be important for its ability to be incorporated and extruded. The size of the piece that can be accommodated in the aerated mallow mix is also dependent on the extruder orifice, extruder piping, static mixer, and the particulate feeder assembly 100. Most often the cross sectional diameter of the piping and static mixer are less than or equal to 3 inches depending on production rate. When making marbits, i.e. extruded mallow that is dried to about 5% moisture or less and often used in Ready To Eat cereal, the typical extruder orifice size is less than or equal to 0.75 inches in diameter based on the internal diameter. In such an extruder the soft candy, chocolate chips, chocolate chunks, bittersweet chocolate pieces, white chocolate pieces, caramel, and butterscotch pieces preferably are sized at 5,000 to 20,000 count per pound, more preferably from 8,000 to 12,000 count per pound. The particulate material like crumbs, fruit, hard candy, and nuts are preferably sized by what passes through a 4 mesh USS and onto a 60 mesh USS, more preferably through a 5 mesh USS onto a 30 mesh USS, and most preferably through a 7 mesh USS onto a 14 mesh USS. When making soft marshmallows having a moisture of about 10% or higher the extruder orifice can be larger and generally it is less than or equal to 1.25 inches on the internal diameter. In such an extruder the soft candy, chocolate chips, chocolate chunks, bittersweet chocolate pieces, white chocolate pieces, caramel, and butterscotch pieces preferably are sized at 1,500 to 10,000 count per pound, more preferably from 2,000 to 5,000 count per pound. The particulate material like crumbs, fruit, hard candy, and nuts are preferably sized by what passes through a 2 mesh USS and onto a 60 mesh USS, more preferably through a 3 mesh USS onto a 30 mesh USS, and most preferably through a 4 mesh USS onto a 14 mesh USS. Depending on the nature of the particulate material it can be helpful to pre-chill the particulate material before or while it is in the primary hopper 102. The pre-chilling is to a temperature below room temperature of generally 70° F., more preferably below 50° F., and most preferably below 40° F. This helps to reduce any tendency for certain particulates like chocolate and caramel to melt in the mallow mix prior to extrusion. Adding a small amount of dextrose to chocolate will also reduce the melting of the chocolate.

The mallow mix with added particulate passes through the in-line static mixer 118 and to an extruder 32. The mallow mix is extruded into a rope 34 having any of a plurality of desired shapes. The extruded rope 34 exits the extruder 32 onto a moving bed conveyor 36 coated with a non-stick coating such as dextrose, glucose, dusting starch, or wax. These non-stick coatings prevent the rope 34 from sticking to the conveyor 36. Additional non-stick coating is deposited onto the top of the rope 34 by a duster 38. Use of the non-stick coating also helps to cause some surface drying to prevent adjacent ropes 34 from sticking to each other, facilitate cutting of the rope 34 and to keep the cut pieces from sticking to each other. The extruded rope 34 is preferably conveyed from the extruder 32 to a cutter 40 over a time period of from 2 to 6 minutes. When the rope 34 reaches the cutter 40 it is cut into appropriate sized pieces, which drop onto a second moving bed conveyor 42 where the cut ends are coated with the non-stick coating from adjacent cut pieces. The cut pieces are then conveyed via conveyor 42 to either a combination dusting and de-dusting drum 44 or through two separate drums comprising a first one for dusting and separating the pieces and a second one for de-dusting to remove excess non-stick coating. The two drum embodiment is not shown. Once the cut pieces are de-dusted, if marbits are being made, they are conveyed to a combination dryer and cooler unit 46 and dried at a temperature of from 110 to 250° F., and more preferably from 10 to 160° F., to a final moisture of from 1 to 5%, and more preferably from 2 to 3%. To form marshmallows utilizing the present process the final drying step in the dryer and cooler unit 46 is eliminated and the cut, separated and de-dusted pieces having a moisture content of from 8 to 30%, more preferably from 10 to 25%, and most preferably from 10 to 20% by weight are the finished product.

The hexametaphosphate colloidal solution has been found to be very advantageous in permitting the film-forming solution to sufficiently gel the mallow mix and rope 34 such that it can be cut by cutter 40 in a reasonable time frame. The addition of particulates to the mallow mix also makes the cutting operation more difficult. A firmer rope 34 results in straighter, cleaner cuts with fewer particulates being displaced by the cutter 40. In the absence of hexametaphosphate the rope 34 takes a much longer time to firm and can not be cut uniformly by cutter 40 unless the moving bed conveyor 36 is made very long.

### EXAMPLE 1

Utilizing the general procedure described above marbits were prepared using the solutions described below following the procedure as above. The sucrose solution was prepared per Table 1A or 1B below by combining the water, sucrose, and corn syrup in first tank 20 at a temperature of 200° F. The dextrose was then added and the mixture was heated to a temperature of from 243 to 246° F. until the final desired Brix was obtained.

TABLE 1A

| Component | Kilograms | Percent by Weight |
|---|---|---|
| Sucrose | 81.72 | 65.72 |
| 42 DE Corn Syrup | 15.39 | 12.38 |
| Water | 14.44 | 11.61 |
| Dextrose | 12.8 | 10.29 |
| Total | 124.35 | 100.00 |

TABLE 1B

| Component | Kilograms | Percent by Weight |
|---|---|---|
| Sucrose | 81.72 | 58.88 |
| 42 DE Corn Syrup | 15.39 | 11.09 |
| Water | 28.88 | 20.81 |
| Dextrose | 12.8 | 9.22 |
| Total | 138.79 | 100.00 |

The film-forming solution was prepared in second tank 22 utilizing the components described in Table 2 below. The gelatin was heated to 170° F. for at least 30 minutes prior to use and maintained at a temperature of from 150 to 165° F.

TABLE 2

| Component | Kilograms | Percent by Weight |
|---|---|---|
| Gelatin | 2.59 | 33.33 |
| Water | 5.18 | 66.67 |
| Total | 7.77 | 100.00 |

To form the mallow mix the sucrose solution from first tank 20 was pumped into third tank 24 and cooled to 180° F. Then the powdered sugar was added to third tank 24. The mallow mixture was then cooled to 165° F. at which point the gelatin solution, flavor, color, and colloidal suspension of hexametaphosphate was added. The hexametaphosphate was made up in the water noted in Table 3 below. The components added to third tank 24 are as noted below in Table 3.

TABLE 3

| Component | Kilograms | Percent by Weight |
|---|---|---|
| Sucrose Solution | 121.5 | 91.62 |
| Gelatin Solution | 7.77 | 5.7 |
| Powdered Sugar | 2.32 | 1.7 |
| Flavor | 0.572 | 0.42 |
| Liquid Color | 0.594 | 0.44 |
| Sodium Hexametaphosphate | 0.027 | 0.02 |
| Water | 0.136 | 0.10 |
| Total | 136.23 | 100.00 |

The formed mallow mix is then pumped through aerator 28 to produce a density of 2.1 pounds per gallon. The aerated solution was pumped through a thermally controlled tube 30 and chilled to 125° F. The chilled solution was then fed through the feeder assembly 100 where 20% by weight, based on the mallow mix weight, of 10,000 count per pound chocolate pieces were added to the mallow mix. The mallow mix with chocolate pieces was then extruded through extruder 32 with final treatment being as described above under the general procedure.

### EXAMPLE 2

Using the process described in Example 1, the feeder assembly 100 was used to incorporate 28% by weight, based on the total weight of the mallow mix, of a mixture of 60% by weight graham cracker crumbs sized through 7 mesh and collected on a 12 mesh screen and 40% by weight of 10,000 count per pound of chocolate chips into the mallow mix.

### EXAMPLE 3

Using the process described in Example 1, the feeder assembly 100 was used to incorporate 19.3% by weight, based on the total weight of the mallow mix, of cookie crumbs sized through 7 mesh and collected on a 12 mesh screen into the mallow mix.

### EXAMPLE 4

Utilizing the general procedure described above a Kosher mallow mix is prepared using the solutions described below following the procedure as above. The sucrose solution is prepared per Table 4 below by combining the water, sucrose, and corn syrup in first tank 20 at a temperature of 200° F. The dextrose is then added and the mixture is heated to a temperature of from 243 to 246° F.

TABLE 4

| Component | Kilograms | Percent by Weight |
|---|---|---|
| Sucrose | 81.72 | 65.69 |
| 64 DE Corn Syrup | 15.44 | 12.41 |
| Water | 14.53 | 11.68 |
| Dextrose | 12.71 | 10.22 |
| Total | 124.40 | 100.00 |

The film-forming solution used is spray dried egg albumen powder hydrated in cold water, strained, and added to tank 22 utilizing the components described in Table 5 below.

TABLE 5

| Component | Kilograms | Percent by Weight |
|---|---|---|
| Egg Albumen | 5.45 | 33.33 |
| Water | 10.90 | 66.67 |
| Total | 16.34 | 100.00 |

To form the mallow mix the sucrose solution from first tank 20 is pumped into third tank 24 and cooled to 180° F. Then the powdered sugar is added to third tank 24. The mallow mixture is then cooled to 140° F. at which point the albumen solution, flavor, and solution of hexametaphosphate are added. The hexametaphosphate is made up in the water noted in Table 6 below. The components added to third tank 24 are as noted below in Table 6

TABLE 6

| Component | Kilograms | Percent by Weight |
|---|---|---|
| Sucrose Solution | 122.2 | 86.79 |
| Albumen Solution | 16.34 | 11.31 |
| Powdered Sugar | 2.32 | 1.60 |
| Flavor | 0.272 | .19 |
| Sodium Hexametaphosphate | 0.027 | .019 |
| Water | 0.136 | 0.09 |
| Total | 136.23 | 100.00 |

The formed mallow mix is then pumped through aerator 28 to produce a density of 2.1 pounds per gallon. The aerated solution is pumped through a thermally controlled tube 30 and chilled to 125° F. The chilled solution is then fed through the feeder assembly 100 where the desired particulate material is added. The mallow mix with particulate is then extruded through extruder 32 with final treatment being as described above under the general procedure.

The present invention discloses a method for incorporating a wide variety of particulate material into either marbits or marshmallows, unlike previously disclosed formulations. The marbits and marshmallows according to the present invention have unique compositions not previously available. The foregoing invention has been described in accordance with the relevant legal standards; thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. An aerated confection comprising from 1.0 to 50% by weight based on the total weight of the aerated confection of at least one particulate material and having a moisture content of from 1 to 5% by weight based on the total weight.

2. The aerated confection of claim 1 having a moisture content of from 2 to 3% by weight based on the total weight.

3. The aerated confection of claim 1 comprising from 5 to 40% by weight of said at least one particulate material.

4. The aerated confection of claim 1 comprising from 10 to 30% by weight of said at least one particulate material.

5. The aerated confection of claim 1 wherein said at least one particulate material comprises soft candy pieces, chocolate chips, chocolate chunks, bittersweet chocolate pieces, white chocolate pieces, butter scotch pieces, caramel pieces, solid peanut butter pieces, fruit pieces, hard candy pieces, nut pieces, graham cracker crumbs, cookie crumbs, and mixtures thereof.

6. The aerated confection of claim 1 wherein said at least one particulate material has an average size of from 5,000 to 20,000 count per pound of particulate material.

7. The aerated confection of claim 1 wherein said at least one particulate material has an average size of from 8,000 to 12,000 count per pound of particulate material.

8. The aerated confection of claim 1 wherein said at least one particulate material has an average size that passes through a 4 mesh USS and onto a 60 mesh USS.

9. The aerated confection of claim 1 wherein said at least one particulate material has an average size that passes through a 5 mesh USS onto a 30 mesh USS.

10. The aerated confection of claim 1 wherein said at least one particulate material has an average size that passes through a 7 mesh USS onto a 14 mesh USS.

11. The aerated confection of claim 1 comprising from 0.02 to 0.05% by weight of a hexametaphosphate.

12. The aerated confection of claim 1 further comprising from 0.1 to 3% by weigh of at least one flavor or color.

13. The aerated confection of claim 1 further comprising from 1 to 20% by weight on a dry weight basis of seed sugar.

14. The aerated confection of claim 1 further comprising from 0.5 to 15% by weight of a film forming agent.

15. An aerated confection comprising from 1.0 to 50% by weight based on the total weight of the aerated confection of at least one particulate material and having a moisture content of from 8 to 30% by weight based on the total weight.

16. The aerated confection of claim 15 having a moisture content of from 10 to 25% by weight based on the total weight.

17. The aerated confection of claim 15 comprising from 5 to 40% by weight of said at least one particulate material.

18. The aerated confection of claim 15 comprising from 10 to 30% by weight of said at least one particulate material.

19. The aerated confection of claim 15 wherein said at least one particulate material comprises soft candy pieces, chocolate chips, chocolate chunks, bittersweet chocolate pieces, white chocolate pieces, butter scotch pieces, caramel pieces, solid peanut butter pieces, fruit pieces, hard candy pieces, nut pieces, graham cracker crumbs, cookie crumbs, and mixtures thereof.

20. The aerated confection of claim 15 wherein said at least one particulate material has an average size of from 1,500 to 20,000 count per pound of particulate material.

21. The aerated confection of claim 15 wherein said at least one particulate material has an average size of from 2,000 to 12,000 count per pound of particulate material.

22. The aerated confection of claim 15 wherein said at least one particulate material has an average size that passes through a 2 mesh USS onto a 60 mesh USS.

23. The aerated confection of claim 15 wherein said at least one particulate material has an average size that passes through a 3 mesh USS onto a 30 mesh USS.

24. The aerated confection of claim 15 wherein said at least one particulate material has an average size that passes through a 4 mesh USS onto a 14 mesh USS.

25. The aerated confection of claim 15 comprising from 0.02 to 0.05% by weight of a hexametaphosphate.

26. The aerated confection of claim 15 further comprising from 0.1 to 3% by weigh of at least one flavor or color.

27. The aerated confection of claim 15 further comprising from 1 to 20% by weight on a dry weight basis of seed sugar.

28. The aerated confection of claim 15 further comprising from 0.5 to 15% by weight of a film forming agent.

29. A method of forming a particulate containing aerated mallow mixture comprising the steps of:
a) providing an aerated mallow mixture having a density of from 1.5 to 4 pounds per gallon and under positive pressure;
b) adding to said aerated mallow mixture at least one particulate material in an amount of from 1 to 50% by weight based on the weight of the mallow mixture while maintaining said aerated mallow mixture under positive pressure;
c) providing said aerated mallow mixture having said particulate material to an extruder and extruding said aerated mallow mixture having said particulate material into a shape.

30. The method of claim 29 wherein in step a) further comprises cooling the aerated mallow mixture of step a) to a temperature of from 90 to 170° F. prior to adding said at least one particulate material.

31. The method of claim 29 wherein in step a) further comprises cooling the aerated mallow mixture of step a) to a temperature of from 115 to 145° F. prior to adding said at least one particulate material.

32. The method of claim 29 wherein in step a) further comprises cooling the aerated mallow mixture of step a) to a temperature of from 125 to 135° F. prior to adding said at least one particulate material.

33. The method of claim 29 wherein step b) comprises adding from 5 to 40% by weight of said at least one particulate material to said aerated mallow mixture.

34. The method of claim 29 wherein step b) comprises adding from 10 to 30% by weight of said at least one particulate material to said aerated mallow mixture.

35. The method of claim 29 wherein step b) comprises adding as said at least one particulate material soft candy pieces, chocolate chips, chocolate chunks, bittersweet chocolate pieces, white chocolate pieces, butter scotch pieces, caramel pieces, solid peanut butter pieces, fruit pieces, hard candy pieces, nut pieces, graham cracker crumbs, cookie crumbs, and mixtures thereof.

36. The method of claim 29 wherein step b) comprises at least one particulate material having an average size of from 1,500 to 20,000 count per pound of particulate material.

37. The method of claim 29 wherein step b) comprises at least one particulate material having an average size of from 2,000 to 12,000 count per pound of particulate material.

38. The method of claim 29 wherein step b) comprises at least one particulate material having an average size that passes through a 2 mesh USS onto a 60 mesh USS.

39. The method of claim 29 wherein step b) comprises at least one particulate material having an average size that passes through a 3 mesh USS onto a 30 mesh USS.

40. The method of claim 29 wherein step b) comprises at least one particulate material having an average size that passes through a 7 mesh USS onto a 14 mesh USS.

41. The method of claim 29 wherein step b) further comprises pre-chilling the particulate material to a temperature below 70° F. prior to adding it to the aerated mallow mixture.

42. The method of claim 29 comprising the further step of drying the extruded aerated mallow mixture containing particulate material to a moisture content of from 1 to 5% by weight.

43. The method of claim 29 comprising the further step of drying the extruded aerated mallow mixture containing particulate material to a moisture content of from 2 to 3% by weight.

44. The method of claim 29 comprising the further step of drying the extruded aerated mallow mixture containing particulate material to a moisture content of from 8 to 30% by weight.

45. The method of claim 29 comprising the further step of drying the extruded aerated mallow mixture containing particulate material to a moisture content of from 10 to 25% by weight.

46. The method of claim 29 comprising the further step of drying the extruded aerated mallow mixture containing particulate material to a moisture content of from 10 to 20% by weight.
